(19) United States
(12) Patent Application Publication
(10) Pub. No.: US 2016/0042664 A1
(43) Pub. Date: Feb. 11, 2016

(54) ELECTRONICS DEMONSTRATION AND TUTORIAL MODE SYSTEM

(71) Applicant: Toyota Motor Engineering & Manufacturing North America, Inc., Erlanger, KY (US)

(72) Inventor: Samuel T. Haberl, Ann Arbor, MI (US)

(21) Appl. No.: 14/456,532

(22) Filed: Aug. 11, 2014

(51) Int. Cl. G09B 19/16; G09B 7/00; G09B 5/06; G06F 3/01; G06F 3/16

(52) U.S. Cl. CPC G09B 19/167; G06F 3/013; G06F 3/016; G06F 3/167; G09B 5/06; G09B 7/00

(57) ABSTRACT

A demonstration and tutorial mode system for a vehicle. The system includes a plurality of vehicle sub-systems and an electronic display. In addition, an electronic display control unit (EDCU) having a processor and a memory is included. The EDCU is in communication with the electronic display and the plurality of vehicle sub-systems (VSSs). The electronic display and EDCU have a demo mode that is operable to display demo mode information to a user on one of the VSSs in response to the VSS being activated by the user. The electronic display and EDCU also have a tutorial mode that is operable to display tutorial mode information on one of the VSSs in response to an inquiry on the VSS by the user.

### FIELD OF THE INVENTION

The present disclosure is directed to an electronics demonstration and tutorial mode, and in particular to an electronics demonstration and tutorial mode that educates an automobile customer about a vehicle and associated vehicle sub-systems.

### BACKGROUND OF THE INVENTION

Vehicles having a plurality of vehicle sub-systems such as interior lighting systems, exterior lighting systems, cruise control systems, HVAC systems, and the like are known. Electronic display systems within vehicles are also known.

In addition to the above, the number of vehicle sub-systems, as well as their operation, has become ever more complex. Furthermore, users of such vehicles desire to have ever increasing convenient methods and techniques to learn how to use the vehicle sub-systems. As such, looking up information in traditional vehicle user manuals has become less desirable. Therefore, an improved system for showing a user of a vehicle how to use various vehicle sub-systems and/or where a particular vehicle sub-system is located would be desirable.

### SUMMARY OF THE INVENTION

A demonstration and tutorial mode system for a vehicle is provided and in some instances, the system is interactive with a user of the vehicle. The system includes a plurality of vehicle sub-systems (VSSs) and an electronic display. In addition, an electronic display control unit (EDCU) having a processor and a memory is included. The EDCU is in communication with the electronic display and the plurality of VSSs.

The electronic display and EDCU have a demonstration (demo) mode that is operable to display demo mode information to a user on a VSS in response to the VSS being activated by the user. The electronic display and EDCU also have a tutorial mode that is operable to display tutorial mode information on a VSS in response to an inquiry on the VSS by the user. It is appreciated that the electronic display can be any electronic display known to those skilled in the art, illustratively including a vehicle console display such as an LCD type screen, a touch screen, etc.

The plurality of VSSs include any VSS known to those skilled in the art, illustratively including systems for or related to a vehicle's cruise control, front windshield wiper, rear windshield wiper, horn, interior lighting, exterior lighting, turn signal, gas cap door, trunk release, hood release, door locks, seat positioning, seat heating, seat cooling, radio, CD player, DVD player, HVAC, navigation, telephone, and the like.

The demo mode information includes any demonstration information for a VSS such as identification (ID) information on an activated VSS and/or functional information on the activated VSS. The tutorial mode information includes any tutorial information for a VSS such as location of the VSS, how the VSS works and the like. Also, the demo mode and/or tutorial mode information can be in the form of visual data, audible data, tactile data, and combinations thereof. The visual data can be in the form of video data, textual data, photographic data, schematic diagram data, and combinations thereof.

In some instances, the tutorial mode of the electronic display and EDCU is operable to request interaction from the user and the VSS that has been inquired about. The interaction from the user can be in the form of tactile interaction or a verbal response. For example, the tactile interaction can be a touch, a push, a pull, and/or a rotation of a component of the VSS that has been inquired about. Furthermore, it is appreciated that the touch or push can be with respect to an electronic sensor such as a capacitive button, etc. The interaction from the user can also be in the form of one or more proximity sensors known to those skilled in the art, for example, an eye tracking camera that follows or detects that a user's eye(s) are looking in a certain direction, at a certain vehicle sub-system, etc. Other proximity sensors not yet known and/or developed in the future are also included within one or more embodiments. Finally, the interaction can include a voice-recognition system where a user can verbally interact with the demonstration and tutorial mode system.

A process for displaying interactive demonstration and tutorial mode information to a user is also disclosed herein. The process includes providing the interactive demonstration and tutorial mode system noted above and disclosed herein. Thereafter, the user initiates a demo mode on the system and activates one of the VSSs of the vehicle. The EDCU detects the activated VSS, retrieves data on the activated VSS, and displays the retrieved data on the electronic display. In addition, or in the alternative, the user can initiate the tutorial mode on the system and select a VSS tag or symbol on the electronic display. The EDCU then activates a VSS indicator on the selected VSS, which in turn allows the user to identify the selected VSS on the vehicle. The EDCU also retrieves data on the activated VSS and displays the retrieved data on the electronic display for tutorial instruction to the user.

### BRIEF DESCRIPTION OF THE DRAWINGS

FIG. 1 is a schematic illustration of a portion of an interior of a vehicle having an embodiment according to the present invention;

FIG. 2 is a schematic illustration of an embodiment of the present invention;

FIG. 3 is a schematic illustration of another embodiment of the present invention;

FIG. 4 is a process flowchart according to an embodiment of the present invention;

FIG. 5 is a schematic flowchart according to an embodiment of the present invention;

FIG. 6 is a schematic flowchart illustrating the types of VSS data that can be retrieved and displayed;

FIG. 7 is a schematic illustration of the types of VSS interaction that can be provided by a user;

FIG. 8 is a schematic illustration of an electronic display displaying DEMO MODE information according to an embodiment of the present invention; and

FIG. 9 is a schematic illustration of an electronic displaying TUTORIAL MODE information according to an embodiment of the present invention.

### DETAILED DESCRIPTION OF THE INVENTION

A demonstration (demo) and tutorial mode system for a vehicle is provided. The demo and tutorial mode system allows a user of a vehicle to select and obtain demo and/or tutorial mode information/data on one or more vehicle sub-systems (VSSs). As such, the user can identify the location and/or operational information/data of/on a VSS. In addition, the user can activate a particular VSS and the demo and tutorial mode system can display identification (ID), functional, and/or operational information on the activated VSS. In this manner, improved education and/or operational information about the vehicle is provided to the user. In addition, interaction with one or more VSSs by the user at the direction of the demo and tutorial mode system provides an experiential learning experience for the user.

The demo and tutorial mode system includes a plurality of VSSs and an electronic display which may or may not be one of the VSSs. Also included is an electronic display control unit (EDCU) that has a processor and memory. It is appreciated that the EDCU is in communication, e.g. electronic communication, with the electronic display and each of the plurality of VSSs.

The electronic display and EDCU have a demo mode that is operable, e.g. while the vehicle transmission is in PARK, to display demo mode information to a user in response to a particular VSS being activated by the user. Stated differently, in response to the user selecting and activating a particular VSS, the EDCU detects the activated VSS, retrieves data on the activated VSS, and displays the retrieved data on the electronic display for viewing by the user. As such, if a user desires to know or understand the function of a particular knob, button, switch, etc., within a vehicle interior, the user can touch, push, pull, rotate, etc. the particular component, and the demo mode of the system will identify the activated VSS and provide information thereon. Furthermore, it is appreciated that the touch or push can be with respect to an electronic sensor such as a capacitive button, etc. The interaction from the user can also be in the form of a proximity sensor such as an eye tracking camera that follows or detects that a user's eye(s) are looking in a certain direction, at a certain vehicle sub-system, etc. Finally, the interaction can include a voice-recognition system where a user can verbally interact with the demonstration and tutorial mode system.

The electronic display and EDCU also have a tutorial mode in which the user can select a particular VSS tag or identifier on the electronic display. In response, the EDCU retrieves and displays information on the selected VSS. In addition, the EDCU can activate a VSS indicator on the selected VSS, e.g. a light on or within the VSS, which allows the user to identify the VSS, interact with the VSS, etc. In this manner, the user can search and/or identify a desired VSS tag or identifier on the electronic display and receive tutorial information thereon.

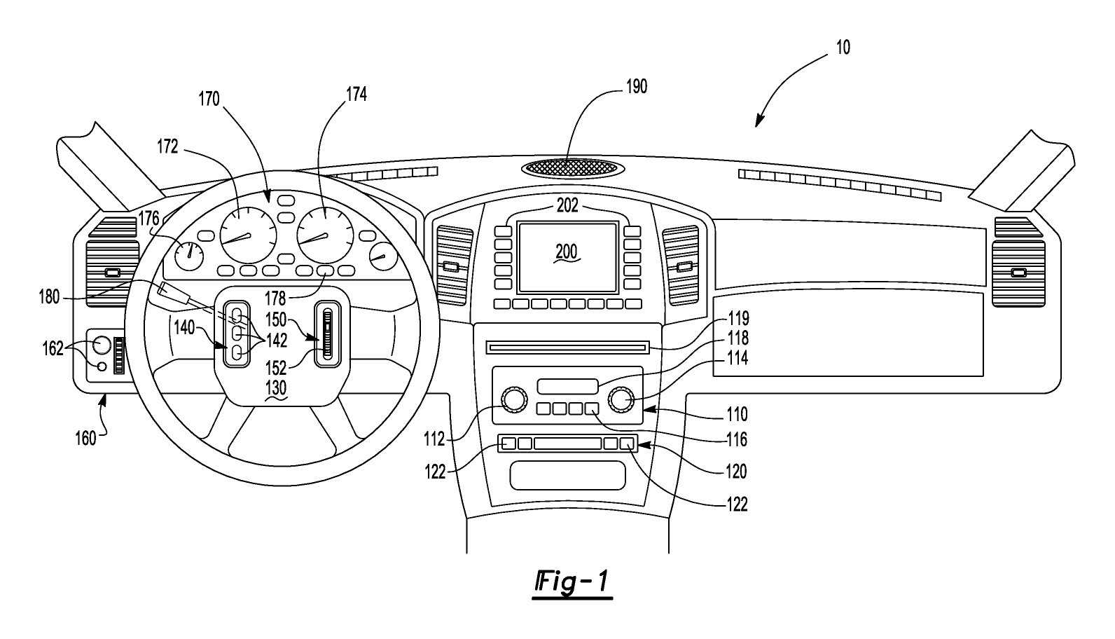

Turning now to FIG. 1, an illustrative interior of a vehicle is shown generally at reference numeral 10. The interior 10 has an inventive demonstration and tutorial mode system which includes a plurality of VSSs 110-170, an electronic display 200, and an electronic display control unit (not shown). The plurality of VSSs can include a radio 110 with a volume control knob/component 112, a station control knob 114, selection buttons 116, display 118, and the like. A CD-receiving slot 119 can also be present with the volume control knob 112, selection buttons 116, and the like operable for selecting tracks on a CD as known to those skilled in the art. The VSSs can also include an HVAC system 120 with various control buttons 122 that can be activated by a user as known to those skilled in the art.

The vehicle interior 10 includes a horn 130, a cruise control system 140 with cruise control buttons or knobs 142, and a windshield wiper system 150 with an optional intermittent control 152. Other modes can be included within the windshield wiper system 150 such as a rain-sensing windshield wiper mode. The interior 10 can also include an interior lighting system 160 with control buttons or knobs 162 and have an instrument panel 170 with a speed indicator 172, an rpm indicator 174, a fuel level indicator 176, and additional information lights/labels 178. Finally, the interior 10 can have a turn signal level/system 180 and speaker system 190.

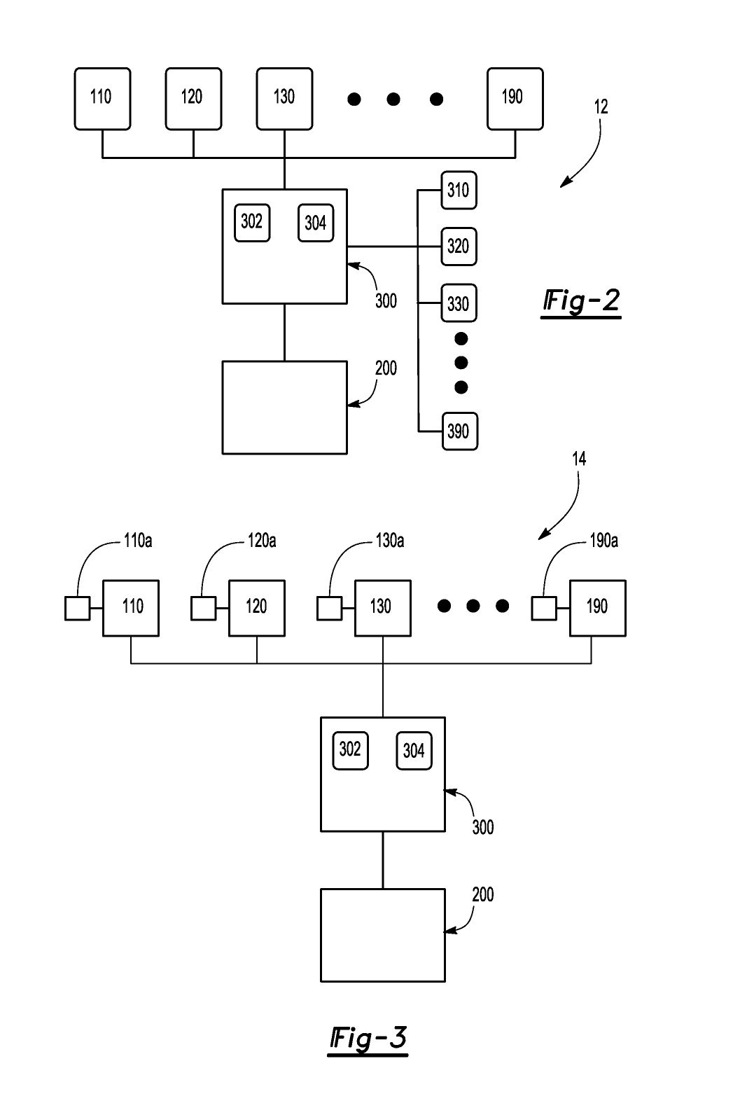

With reference to FIG. 2, a schematic diagram of the embodiment in FIG. 1 is shown generally at reference numeral 12. In particular, the plurality of VSSs 110, 120, 130, . . . 190, the electronic display 200 and an electronic display control unit (EDCU) 300 in communication with each of the VSSs 110-190 and the electronic display 200 is shown. The EDCU has a processor 302 and memory 304. The VSSs include but are not limited to a cruise control system, front windshield wiper system, rear windshield wiper system, horn system, interior lighting system, exterior lighting system, turn signal system, gas cap door system, trunk release system, hood release system, door lock system, seat position system, seat heating system, seat cooling system, audio system, interior air vent system, interior heating system, interior cooling system, navigation system, vehicle telephone system and the like.

In addition, the embodiment 12 includes VSS data 310 that is associated with the VSS 110, VSS data 320 associated with the VSS 120, VSS data 330 associated with the VSS 130, and VSS data 390 associated with the VSS 190. As such, the EDCU 300 has access to VSS data associated with all or at least part of all the VSSs of the vehicle. Furthermore, it is appreciated that the VSS data may or may not be stored within the memory 304.

The EDCU 300 has can detect when a particular VSS is either activated by a user or selected from the electronic display 200 and then retrieve the appropriate VSS data 310-390. The EDCU 300 can also display such data 310-390 onto the electronic display 200 and/or energize an indicator on the selected VSS. For example, if an identifier or tag for the VSS 120 is selected on the electronic display 200 by a user, the EDCU 300 can activate an LED light associated with the VSS 120 such that a user can see where the VSS 120 is located within the vehicle interior 10. In the alternative, if a user directly activates the VSS 120, the EDCU 300 detects that the VSS 120 has been activated, retrieves the VSS data 320 and displays the data on the electronic display 200. Activation of a VSS can include a user simply pushing, pulling, rotating, etc., the VSS—once the system is in demo and/or tutorial mode—which in turn results in the EDCU 300 selecting or retrieving the appropriate data and displaying it onto the electronic display 200. In this manner, a user can quickly determine what a particular knob, button, switch, etc. is, and how it is used.

Turning now to FIG. 3, another embodiment of the system is shown generally at reference numeral 14. The embodiment 14 is similar to the embodiment 12 except that data for each of the VSSs 110-190 is located with each of the sub-systems at 110a, 120a, 130a, . . . 190a instead of at a centralized location as in embodiment 12.

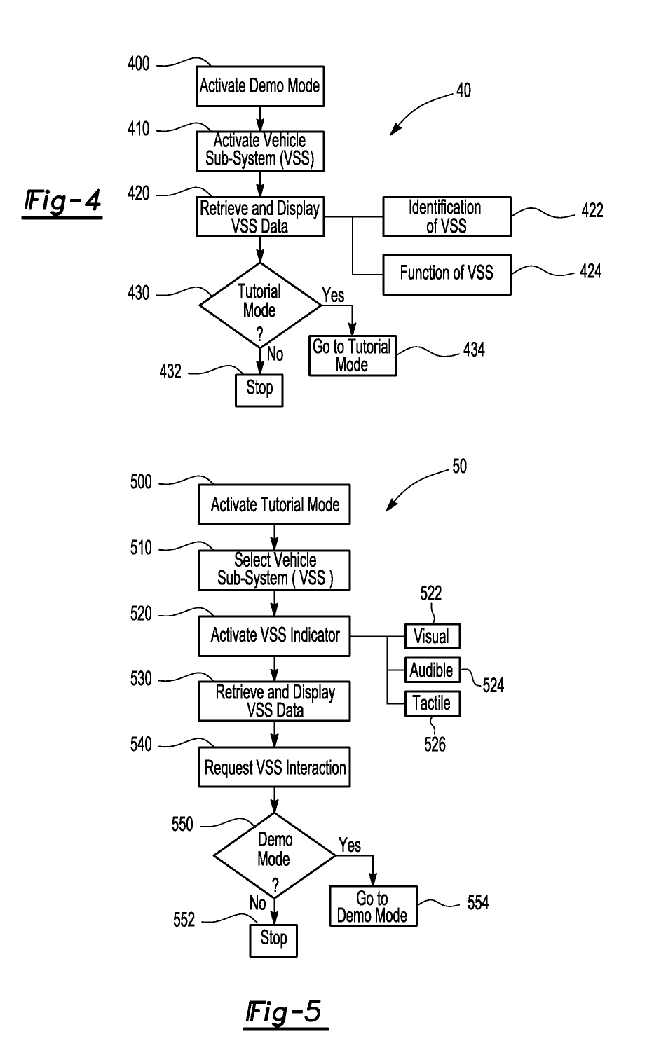

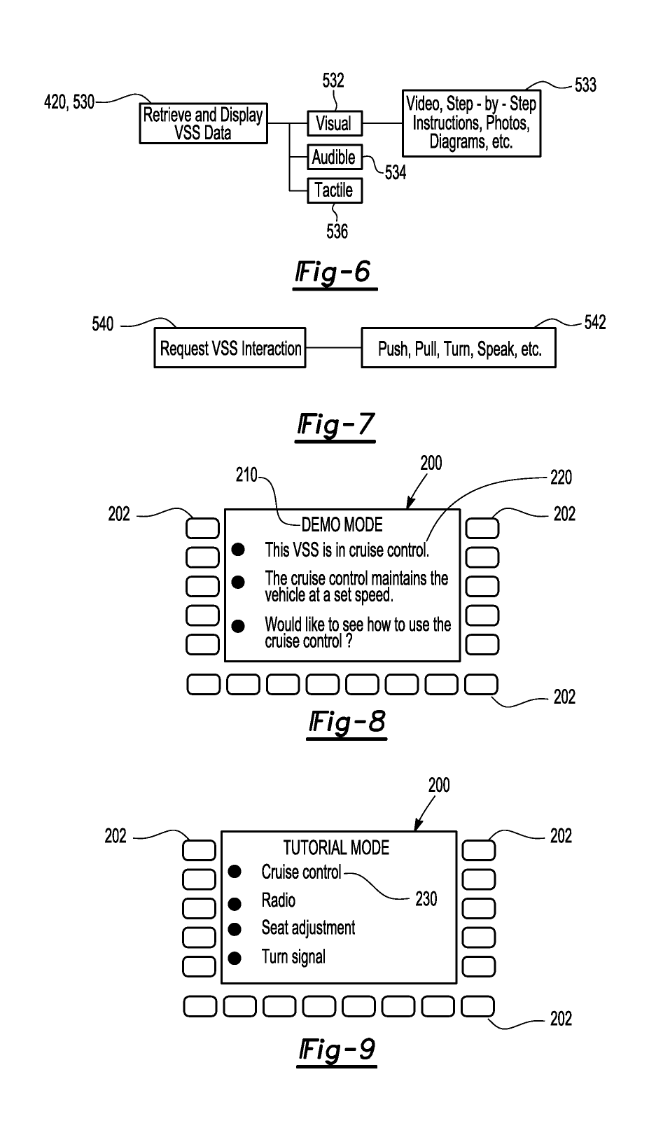

With respect to how the inventive system operates, an illustrative example is shown in FIG. 4 at reference numeral 40. The process or flow chart 40 includes a user activating a demo mode at step 400. Once the system is in the demo mode, the user also activates a VSS at step 410 and VSS data on the VSS is retrieved and displayed at step 420. The type of data retrieved and displayed at step 420 can be ID data on the VSS 422 (e.g. “You have activated the cruise control.”) or function data 424 (e.g. “The cruise control allows you to set a constant speed for the vehicle.”). Upon retrieval and display of the VSS data on the electronic display, the system can alternatively or optionally allow the user to go to a tutorial mode at step 430. If the user selects not to go to the tutorial mode, the system stops at step 432, or in the alternative goes to the tutorial mode at step 434.

FIG. 5 provides an illustrative tutorial mode process or flowchart at reference numeral 50 in which the tutorial mode is activated at step 500. While in the tutorial mode, the user selects a VSS at step 510. The system can optionally activate a VSS indicator at step 520, e.g. an illumination device associated with the VSS. The VSS indicator can be a visual indicator 522, an audible indicator 524, and/or a tactile indicator 526. For example, the visual indicator can be the activation of an LED light or backlight associated with the VSS; the audible indicator 524 can be any type of noise associated with the VSS; and the tactile indicator 526 can be a vibration, a heating sensation, a cooling sensation, and the like associated with the VSS.

Vehicle sub-system data is retrieved and displayed at step 530 and a request for VSS interaction can optionally be included at step 540. For example, upon retrieval and display of the VSS data at step 530, the system can request the user to touch, pull, push, rotate, etc. the particular VSS in order to give the user an experiential interaction with the sub-system. Thereafter, the system can ask the user if they wish to enter the demo mode at step 550. If the user wishes not to enter the demo mode, the system or process goes to stop at step 552. In the alternative, the system or process can go to the demo mode at step 554.

The VSS data retrieved and displayed by the demo mode can be visual data 532, audible data 534, or tactile data 536 as illustrated in FIG. 6. The visual data 532 can be in the form of video data on the electronic display, step-by-step instructions provided on the display, photographs, diagrams, and the like as shown at 533. In addition, the request for VSS interaction 540 can be in the form of a touch, push, a pull, turn, verbal command, etc. as shown at 542.

With reference to FIG. 8, an illustrative electronic display 200 is shown with the demo mode activated shown at 210 and textual information provided at 220. The textual information can provide ID information, e.g. identifying the VSS that has been activated by the user, the function of the VSS. In addition, the textual information/data can ask the user if they would like information on how the VSS works, i.e. enter the tutorial mode and receive tutorial information. In addition to, or in the alternative, photographs, videos, line drawings and the like can be displayed on the electronic display for the user to observe and receive demo and/or tutorial mode information. In another alternative, a speaker 190 within the vehicle interior 10 can be used to provide demo and/or tutorial mode verbal information to the user.

Turning now to FIG. 9, the electronic display 200 while in tutorial mode is shown. In addition, a plurality of VSS tags 230 are illustrated and can be selected by a user via one or more of the buttons 202, or in the alternative by touching the screen if the display is a touch screen type electronic display. Once one of the of the VSS tags 230 are selected, the EDCU 300 can activate a VSS indicator on or within the VSS such that the user can see and/or hear where the VSS is located within the vehicle. In addition, the electronic display 200 and/or speaker 190 can provide visual and/or audible tutorial mode information on the selected VSS. For example, and assuming the user has selected the Radio tag 230, the EDCU 300 can illuminate one or more back lights for the radio display knob 112, display 118, etc., such that the user can easily see where the radio, the volume control knob, etc., is located. The electronic display 200 and/or speaker 190 can also request that the user rotate the volume control knob 112 in order to see how the volume control for the radio works. In this manner, a demonstration and tutorial mode system that provides an experiential learning experience to the user is provided.

It should be appreciated that changes, modifications, and the like will to the embodiments disclosed herein will be apparent to those skilled in the art and yet still fall within the scope of the invention. As such, it is the claims, and all equivalents thereof, that define the scope of the invention.

### REFERENCE NUMERAL LISTING

10—embodiment
12—embodiment
14—embodiment
40—embodiment
50—embodiment
110—vehicle radio
110a—radio data
112—radio volume control knob
114—radio station control knob
116—radio knob
118—radio display screen
120—vehicle HVAC system
120a—HVAC data
122—HVAC control button
130—horn
140—cruise control lever
142—cruise control knob/button
150—windshield wiper lever
152—rear windshield wiper control
160—interior lighting control
162—interior lighting control knob/button
170—instrument panel
172—speed indicator
174—RPM indicator
176—fuel level indicator
178—vehicle subs-system indicator
190—vehicle sub-system
200—electronic display
202—electronic display buttons
210—DEMO MODE label
220—textual information on 200
230—VSS tag on 200
300—electronic display control unit
302—processor
304—memory
310—data on 110
320—data on 120
330—data on 130
390—data on 190
400—activate demo mode process step
410—activate VSS process step
420—retrieve and display VSS data
422—identification of VSS data
424—function of VSS data
430—tutorial mode selection process step
432—stop process step
434—go to tutorial mode process step
500—activate tutorial mode process step
510—select VSS process step
520—activate VSS indicator process step
522—visual indicator
524—audible indicator
526—tactile indicator
530—retrieve and display VSS data
532—visual VSS data
533—video, step-by-step instructions, photos, diagrams, etc. VSS data
534—audible VSS data
536—tactile VSS data
540—request VSS interaction
542—push, pull, turn, speak, etc. interaction
550—demo mode selection process step
552—stop process step
554—go to Demo Mode process step

I claim:

1. A demonstration and tutorial mode system for a vehicle comprising:
a plurality of vehicle sub-systems;
an electronic display; and
an electronic display control unit (EDCU) having a processor and memory, said EDCU in communication with said electronic display and said plurality of vehicle sub-systems (VSSs);
said EDCU having a demonstration (demo) mode operable to display demo mode information to a user on one of said VSSs in response to said VSS being activated by the user on said electronic display;
said EDCU also having a tutorial mode operable to display tutorial mode information on one of said VSSs in response to an inquiry on said VSS by the user on said electronic display.

2. The demonstration and tutorial mode display system of claim 1, wherein said electronic display is a vehicle console display.

3. The demonstration and tutorial mode display system of claim 2, wherein said plurality of vehicle sub-systems is selected from the group consisting of a cruise control system, front windshield wiper system, rear windshield wiper system, horn system, interior lighting system, exterior lighting system, turn signal system, gas cap door system, trunk release system, hood release system, door lock system, seat position system, seat heating system, seat cooling system, audio system, interior air vent system, interior heating system, interior cooling system, navigation system and vehicle telephone system.

4. The demonstration and tutorial mode display system of claim 3, wherein said demo mode information is selected from the group consisting of identification information on said activated VSS and function information on said activated VSS.

5. The demonstration and tutorial mode display system of claim 4, further comprising a speaker, said EDCU operable to transmit said demo mode information audibly through said speaker.

6. The demonstration and tutorial mode display system of claim 5, wherein said tutorial mode information is selected from the group consisting of visual data, audible data, tactile data and combinations thereof.

7. The demonstration and tutorial mode display system of claim 6, wherein said visual data is selected from the group consisting of video data, textual data, photographic data, schematic diagram data and combinations thereof.

8. The demonstration and tutorial mode display system of claim 1, wherein said tutorial mode of said electronic display and EDCU is operable to request interaction with said inquired about VSS by the user.

9. The demonstration and tutorial mode display system of claim 8, wherein said EDCU recognizes interaction from the user in a form of tactile interaction or a verbal response by the user.

10. The demonstration and tutorial mode display system of claim 9, wherein said tactile interaction is selected from the group consisting of a touch, push, a pull and a rotation of a component of said inquired about VSS.

11. A process for providing demonstration and tutorial mode information to a user, the process comprising:
providing a vehicle demonstration and tutorial mode display system having:
an electronic display;
a plurality of vehicle sub-systems; and
an electronic display control unit (EDCU) having a processor and memory, said EDCU in communication with said electronic display and said plurality of vehicle sub-systems (VSSs); and
executing at least one of the following:
initiating a demo mode on the system;
activating one of the VSSs;
the EDCU detecting the activated VSS, retrieving data on the activated VSS and displaying the retrieved data on the electronic display; and
initiating the tutorial mode on the system;
selecting a VSS tag on the electronic display;
activating a VSS indicator on the selected VSS using the EDCU;
the EDCU retrieving data on the activated VSS and displaying the retrieved data on the electronic display.

12. The process of claim 11, wherein the electronic display is a vehicle console display.

13. The process of claim 12, wherein the plurality of vehicle sub-systems is selected from the group consisting of a cruise control system, front windshield wiper system, rear windshield wiper system, horn system, interior lighting system, exterior lighting system, turn signal system, gas cap door system, trunk release system, hood release system, door lock system, seat position system, seat heating system, seat cooling system, audio system, interior air vent system, interior heating system, interior cooling system, navigation system and vehicle telephone system.

14. The process of claim 13, wherein the demo mode information is selected from the group consisting of identification information on the activated VSS and function information on the activated VSS.

15. The process of claim 14, further including providing a speaker, the EDCU transmitting the demo mode information audibly through the speaker.

16. The process of claim 15, wherein the tutorial mode information is selected from the group consisting of visual data, audible data, tactile data and combinations thereof.

17. The process of claim 16, wherein the visual data is selected from the group consisting of video data, textual data, photographic data, schematic diagram data and combinations thereof.

18. The process of claim 11, further including the tutorial mode of the EDCU requesting interaction with the inquired about VSS by the user.

19. The process of claim 18, further including the EDCU recognizing interaction from the user in a form of tactile interaction or a verbal response by the user.

20. The process of claim 19, wherein the tactile interaction is selected from the group consisting of a touch, push, a pull and a rotation of a component of the inquired about VSS.
